(19) United States
(12) Patent Application Publication
(10) Pub. No.: US 2026/0085019 A1
(43) Pub. Date: Mar. 26, 2026

(54) FERTILISER PRODUCT

(71) Applicant: U.S. Borax Inc., Wilmington, DE (US)

(72) Inventors: Sandip Shinde, Wilmington, DE (US); Elzabeth Gingras-Lafleur, Wilmington, DE (US); Judi Becker, Wilmington, DE (US); Fabiano Silvestrin, Wilmington, DE (US)

(21) Appl. No.: 19/111,066

(22) PCT Filed: Sep. 13, 2023
(86) PCT No.: PCT/US2023/032616

§ 371 Date: Mar. 12, 2025

Related U.S. Application Data
(60) Provisional application No. 63/406,693, filed on Sep. 14, 2022.

(51) Int. Cl. C05D 1/02; C05D 9/02; C05G 5/12

(52) U.S. Cl. CPC C05D 1/02; C05D 9/02; C05G 5/12

(57) ABSTRACT

A fertiliser product comprising potassium sulfate (sulfate of potash or “SOP”) and boron, wherein the amount of boron is equivalent to 0.2 to 3.0 wt. % B.

### CROSS REFERENCE TO RELATED APPLICATION

This Application claims priority to U.S. Provisional Patent Application No. 63/406,693 filed on Sep. 14, 2022.

### TECHNICAL FIELD

The present disclosure relates to a fertiliser product.

The present disclosure relates particularly, although by no means exclusively, to a fertiliser product comprising potassium sulfate, i.e. sulfate of potash (SOP), and boron, referred to herein as a SOP+B fertiliser product.

The present disclosure also relates to a process and a plant for producing a SOP+B fertiliser product.

The present disclosure also relates to a process and a plant for making SOP from sodium sulfate waste.

### BACKGROUND

Fertilisers are used to supplement the amount of essential macronutrients in soil, for example nitrogen, potassium, phosphorous, sulphur, calcium and magnesium.

Other elements that are needed in much smaller amounts for plant growth are called micronutrients, such as boron, zinc, manganese, iron, copper, molybdenum and chlorine.

Most of the commercially available fertilisers have a single action only, i.e. they correct a deficiency in either a macronutrient or a micronutrient separately.

Muriate of potash (MOP—potassium chloride) is one commercially available fertiliser product that contains a macronutrient. Potash is a general term that is used to describe alkali potassium-containing compounds in agriculture fertilisers. Potassium is one of the three primary agricultural macronutrients, with the other primary macronutrients being nitrogen and phosphorus.

The two most common forms of potassium for use as primary macronutrients are MOP and sulfate of potash (SOP, i.e. potassium sulfate), with MOP being the most commonly used potassium fertiliser product.

SOP fertiliser products contain two macronutrients, namely potassium (K) and sulphur (S) in a single product and are preferable to MOP fertilisers for plants cultivated in crops that are sensitive to chloride. Unlike MOP fertiliser products, SOP fertiliser products do not contain chlorides. This alternative to well-established MOP fertiliser products has gained a foothold in agriculture as a premium product for high-value and chloride-sensitive crops, as well as a source of sulphur and a much lower salinity.

There are fertilisers on the market that are combinations of macronutrients and micronutrients.

For example, a fertiliser sold under the trade mark Aspire™+B from The Mosaic Company comprises MOP+0.5B—see US20190292111. As noted above, MOP contains a macronutient and boron is a micronutrient. In addition, a fertiliser sold under the trade mark Patentkali®+B from K+S Asia Pacific Pte Ltd comprises 6% Mg and 0.5% B, and K in the form of potassium sulfate, i.e. two macronutrients and one micronutrient.

There are other fertilisers disclosed in the patent literature that are combinations of macronutrients and micronutrients.

The applicant's view is that there are no viable commercially available fertiliser products that combine macronutrients and micronutrients in one product catering towards high-value crops.

Most commercial fertilisers are water-soluble quick-release fertilisers that are readily available for plants when appropriately placed in soil. Quick-release fertilisers are available to plants at a consistent rate and release all readily available nutrients in a short period of time after being applied to soil.

Their quick-release mechanism does not always match the needs of crop growth as excess nutrients may be readily available to a crop before it has any use for them and nutrients will not be available when the crop needs them. This can lead to adverse effects in the crop, particularly for nutrient-sensitive crops of high value which can be seen in the form of burning or nutrient loss through leaching or runoff. As crops develop, their nutrient requirements may vary and multiple fertiliser applications can be used to satisfy crop nutrient demand and increase the efficiency of fertiliser usage.

To accommodate for the plant growth cycle of crops, slow-release and controlled-release fertilisers have been developed.

The applicant has developed a formulation for a fertiliser product that has potential to cover the growth cycle of crops.

It is understood that the above description is not to be taken as an admission of the common general knowledge anywhere.

### SUMMARY OF THE DISCLOSURE

The present disclosure provides a fertilizer product that can provide K, S and B, i.e. two macronutrients and one micronutrient, to soil in one product.

Suitably, the present disclosure provides a potassium sulfate, i.e. sulfate of potash (SOP)+boron, i.e. a SOP+B, fertiliser product which provides two macronutrients and a micronutrient within the same compound.

The SOP+B fertiliser product of the disclosure allows farmers to use a single fertiliser product to correct potassium and sulphur deficiencies in soils while providing boron in sufficient quantities for growth of plants in crops.

The exact quantity of boron in the fertiliser product can be selected based on the boron demand of the crops.

According to the present disclosure, there is provided a fertiliser product comprising potassium sulfate (sulfate of potash or “SOP”) and boron, wherein the amount of boron is equivalent to 0.2 to 3.0 wt. % B.

The amount of boron in the fertiliser product may be equivalent to more than 0.5 wt. % B.

The amount of boron in the fertiliser product may be equivalent to more than 0.6 wt. % B.

The amount of boron in the fertiliser product may be equivalent to more than 0.9 wt. % B.

The amount of boron in the fertiliser product may be equivalent to no more than 10 wt. % B.

The amount of boron in the fertiliser product may be equivalent to no more than 7 wt. % B.

The amount of boron in the fertiliser product may be equivalent to no more than 1.75 wt. % B.

The amount of boron in the fertiliser product may be equivalent to no more than 1.5 wt. % B.

The amount of boron in the fertiliser product may range from 5 to 7 wt. % B.

The fertiliser product may comprise boron in any one or more than one of the boron-containing compounds boric acid, borax pentahydrate, anhydrous borax, boric oxide, kernite, ulexite, colemanite, hydroboracite, borax decahydrate, zinc borate, tincal and disodium octaborate tetrahydrate (DOT) or combinations thereof.

The fertiliser product may comprise a micronutrient in addition to boron.

The fertiliser product may further comprise a micronutrient selected from a group consisting of iron, molybdenum, cobalt, manganese, nickel, copper, zinc or a combination thereof.

The additional micronutrient may be any suitable micronutrient such as zinc.

The zinc may be in a form of zinc acetate, zinc fluoride, zinc bromide, zinc nitrate, zinc chloride, zinc iodide, zinc oxide, zinc permanganate, zinc sulfate heptahydrate, zinc sulfate monohydrate, zinc sulfite, zinc tartrate, zinc oxysulfate, zinc EDTA, and zinc ammonia salts.

The additional micronutrient may be any one of the following micronutrients in the following forms:
1) Micronutrient iron: iron (II) carbonate, iron (II) nitrate, iron (II) chloride, iron (II) hydroxide, iron (II) oxalate, iron (II) sulfate, iron (III) chloride, iron (III) fluoride, iron (III) hydroxide, iron (III) nitrate, iron (III) sulfate, iron EDTA.
2) Micronutrient manganese: manganese (II) bromide, manganese (II) carbonate, manganese (II) chloride, manganese (II) hydroxide, manganese (II) nitrate, manganese (II) fluoride, manganese (II) oxalate, manganese (II) sulfate, manganese oxy-sulfate, manganese EDTA.
3) Micronutrient copper (not commonly needed): copper (I) chloride, copper (I) hydroxide, copper (I) iodide, copper (I) sulfide, copper (I) oxide, copper (II) fluoride, copper (II) bromide, copper (II) carbonate, copper (II) chloride, copper (II) hydroxide, copper (II) nitrate, copper (II) oxide, copper oxalate, copper (II) sulfate, copper (II) sulfide, copper EDTA.
4) Micronutrient molybdenum: ammonium molybdate, molybdenum trioxide, molybdenum disulfide, calcium molybdate, magnesium molybdate.
5) Micronutrient nickel: nickel sulfate, nickel bromide, nickel carbonate, nickel chloride, nickel fluoride, nickel formate, nickel hydroxide, nickel iodide, nickel nitrate, nickel oxalate, nickel sulfate.
6) Micronutrient cobalt (not commonly needed): cobalt (II) fluorosilicate, cobalt (II) iodide, cobalt (II) nitrate, cobalt (II) nitrite, cobalt (II) oxalate, cobalt (II) sulfate, cobalt (II) chloride, cobalt (II) bromide, cobalt (II) fluoride.

The fertiliser product may comprise a macronutrient in addition to potassium and sulphur.

The additional macronutrient may be any one of the following macronutrients in the following forms:
1) Macronutrient phosphorous: super phosphate, concentrated super phosphate, mono-ammonium phosphate, di-ammonium phosphate, ammonium polyphosphate, phosphoric acid, phosphorous acid, phosphonic acids, bone ash, bone meal, rock phosphates.
2) Macronutrient magnesium: magnesium acetate, magnesium bromide, magnesium carbonate, magnesium chloride, magnesium formate, magnesium hydroxide, magnesium fluoride, magnesium iodide, magnesium nitrate, magnesium oxalate, magnesium oxide, magnesium phosphate, magnesium sulfate, magnesium sulfite, magnesium thiosulfate, magnesium selenite.
3) Macronutrient calcium: calcium acetate, calcium benzoate, calcium bicarbonate, calcium bromide, calcium carbonate, calcium fluoride, calcium chloride, calcium citrate, mono-calcium phosphate, calcium formate, di-calcium phosphate, calcium hydroxide, calcium iodide, calcium nitrate, calcium nitrite, calcium oxalate, calcium oxide, calcium phosphate, calcium selenite, calcium sulfate.

The fertiliser product may be in a form of compacted granules or pellets.

The term “granule” is understood herein to mean to a small compact particle of material, which may have a regular or irregular shape.

A granule may be formed by agglomeration or compaction or otherwise, which may further be followed by crushing.

The term “pellet” is understood herein to mean a particle of material, which suitably has a regular shape. A pellet may be formed by compression or compaction or molding or otherwise.

The granules or pellets may be compacted to provide required mechanical properties for materials handling of the granules or pellets.

The granules or pellets may be compacted in a compaction or dry granulation process.

Alternatively, the granules or pellets may be compacted using other granulation processes, such as wet granulation in a disc or other suitable pelletizer or fluidized bed or high energy mixing granulator.

The granules or pellets may be 1-5 mm in size, typically 2-4 mm in size.

The fertiliser product may be a slow-release product.

The term “slow-release” is understood herein to mean the release of nutrients in the soil occurs gradually over a period of time because the nutrients are in a form that is not readily available for plant uptake in crops until some time has elapsed after the fertiliser has been applied.

The fertiliser product may be a controlled-release product.

The term “controlled-release” is understood herein to mean the release of nutrients in the soil is controlled to match the dynamic nutrient requirements in crops. Controlled-release fertilisers typically contain water-soluble nutrients that are coated or encapsulated with a material that controls the rate of nutrient release in crops. The coating is typically a semi-permeable material that allows the rate, pattern and duration of nutrient release to be controlled.

The fertiliser product may comprise granules or pellets and a coating to control the release of macronutrients and micronutrients from the granules or pellets.

The coating may be made from any suitable material.

The coating may be made from a polymeric material.

The coating may be made from a sulphur-containing polymer material.

The coating may include any one of the following materials.
Inorganic materials: bentonite, phosphogypsum, gypsum, hydroxy apatite, zeolites, sepiolite.
Synthetic polymers: polyurethane, polyethylene, polyacrylamide, polycaprolactone, polystyrene, polysulfone, aliphatic polyester, polyvinyl alcohol, bio-based epoxy.
Natural polymers: starch, cellulose, chitosan, ethyl cellulose, carboxymethyl cellulose, hydroxy methyl cellulose, hydroxypropyl methylcellulose, bio-based polyurethane, polysulfone, latex, natural rubber, lignin, alginate.
Hydrophobic sealants: paraffin, polyols.

The coating may be formed by any one of the following coating techniques: rotary drum, pan, fluidized bed, melting and extrusion, solution polymerization and crosslinking, inverse suspension polymerization, and microwave irradiation.

The fertiliser product may further comprise a binder.

The binder may be any suitable material.

The binder may be a starch.

The binder may be water.

According to the present disclosure, there is also provided a process for producing a fertiliser product comprising:
(a) blending together, for example by dry mixing or wet mixing, potassium sulfate (sulfate of potash or “SOP”) and one or more than one boron-containing compound; and
(b) compacting, agglomerating or otherwise forming the blended potassium sulfate and boron-containing compound(s) into granules or pellets.

Water may be added during the blending step (a).

When blending step (a) is a dry mixing step, the process may comprise adding up to 30 wt. % moisture before forming step (b). Suitably, the process comprises adding up to 20 wt. % moisture before forming step (b). More suitably, the process comprises adding up to 10 wt. % moisture before forming step (b). Even more suitably, the process comprises adding up to 2 wt. % moisture before forming step (b).

When blending step (a) is a wet mixing step, the process may include drying the blended potassium sulfate and boron-containing compound(s) to form a mixture having a moisture content of not more than 30 wt. % before forming step (b). Suitably, the process comprises drying the blended potassium sulfate and boron-containing compound(s) to form a mixture having a moisture content of not more than 20 wt. % before forming step (b). More suitably, the process comprises drying the blended potassium sulfate and boron-containing compound(s) to form a mixture having a moisture content of not more than 10 wt. % before forming step (b). Even more suitably, the process comprises drying the blended potassium sulfate and boron-containing compound(s) to form a mixture having a moisture content of not more than 2 wt. % before forming step (b).

The process may include drying the granules or pellets.

The SOP and the boron-containing compound(s) may be dry powders.

The process may comprise forming SOP by any suitable process.

The SOP may be produced by a Mannheim process.

The SOP may be produced by a Glaserite process.

The SOP may be produced by complex-salt crystallization, typically when the SOP is isolated from mined salts or brines.

The process may comprise supplying a sodium sulfate waste stream and potassium chloride as feed materials for the Glaserite process and forming SOP.

The boron-containing compound(s) may be selected from any one or more than one of boric acid, borax pentahydrate, anhydrous borax, boric oxide, kernite, ulexite, colemanite, hydroboracite, borax decahydrate, zinc borate, tincal and disodium octaborate tetrahydrate (DOT) or a combination thereof.

Blending step (a) may comprise mixing a binder with potassium sulfate and the boron-containing compound(s).

The binder may be a starch.

The binder may be water.

Blending step (a) may be a bulk blending step in which the compounds are added together at the same time and then mixed together.

Blending step (a) may comprise any suitable sequence of adding and mixing the compounds.

The process may comprise crushing the granules or pellets produced in the granule/pellet-forming step (b).

The process may comprise classifying, for example screening, the granules or pellets and separating the classified granules or pellets on the basis of size and producing a product fraction.

The process may comprise classifying, for example by screening, the granules or pellets into an oversize fraction, a product fraction, and an undersize fraction.

The product fraction may be any suitable size fraction.

The product fraction may be at least 1 mm.

The product fraction may be at least 2 mm.

The product fraction may be no more than 6 mm.

The product fraction may be no more than 5 mm.

The product fraction may be no more than 4 mm.

The product fraction may be a 1-4 mm size fraction.

The product fraction may be a 1-5 mm size fraction.

The product fraction may be a 1-6 mm size fraction.

The process may comprise returning the oversize fraction to the classification step.

The process may comprise returning the undersize fraction to the compaction step.

The process may comprise drying the product fraction to form the fertiliser product.

The present disclosure also provides a process for producing a fertiliser product that comprises potassium sulfate (sulfate of potash or “SOP”) and boron, the process comprising:
(a) blending together SOP and one or more than one boron-containing compounds and optionally other micronutrients,
(b) compacting, agglomerating or otherwise forming the blend into granules or pellets,
(c) screening or otherwise classifying the granules or pellets and forming a product fraction, and
(d) drying the granules or pellets in the product fraction and forming the fertiliser product.

Water may be added during the blending step (a).

The process may comprise crushing the granules or pellets produced in the granule/pellet-forming step.

The classifying step may comprise producing an oversize fraction, an undersize fraction, and a product fraction.

The process may comprise a crushing step after classifying step (c). Suitably, the process comprises returning the crushed material after the screening step to the blending step.

The crushed material may comprise either or a mixture of crushed oversize material and undersized material.

The process may comprise returning the oversize fraction to the crushing step.

The process may comprise returning the undersize fraction to the granule/pellet-forming step (b).

The process may comprise making SOP to be supplied to the blending step by processing a sodium sulfate waste stream and potassium chloride, for example in a Glaserite process, and forming SOP.

The sodium sulfate waste stream may be obtained from any suitable source.

The sodium sulfate waste stream may be obtained from mineral processing operations such as the boric acid/lithium production processes, including existing storage ponds and tailings dams of those operations.

The potassium chloride may be obtained from any suitable source.

The SOP may be produced by a Mannheim process.

The SOP may be produced by complex-salt crystallization, typically when the SOP is isolated from mined salts or brines.

The present disclosure also provides a plant for producing a fertiliser product that comprises potassium sulfate (sulfate of potash or “SOP”) and boron, the plant comprising:
(a) a blending unit blending together SOP and one or more than one boron-containing compounds,
(b) a compaction unit or other suitable unit for forming the blend into granules or pellets,
(c) a screening or other classification unit for the granules and pellets and producing a product fraction; and
(d) drying the granules or pellets in the product fraction and forming the fertiliser product.

The plant may comprise a crushing unit for crushing the granules or pellets produced in the compaction unit or other suitable granule/pellet-forming unit.

The crushing unit may be used to crush the compacted material from the compaction unit (b).

The plant may comprise a unit, such as a Glaserite process unit, for making SOP from a sodium sulfate waste source and potassium chloride.

### BRIEF DESCRIPTION OF THE DRAWINGS

The present disclosure is described further by way of example with reference to the accompanying drawings, of which:

FIG. 1 is a flowsheet illustrating one embodiment of a process and a plant for producing a SOP+B fertiliser product according to the present disclosure;

FIG. 2 is a flowsheet illustrating another embodiment of a process and a plant for producing a SOP+B fertiliser product according to the present disclosure;

FIG. 3 is a flowsheet illustrating another, but not the only other, embodiment of a process and a plant for producing a SOP+B fertiliser product according to the present disclosure; and

FIG. 4 is a flowsheet illustrating one embodiment of the steps in the granulation process and a plant of FIG. 1 according to the present disclosure.

### DESCRIPTION OF EMBODIMENTS

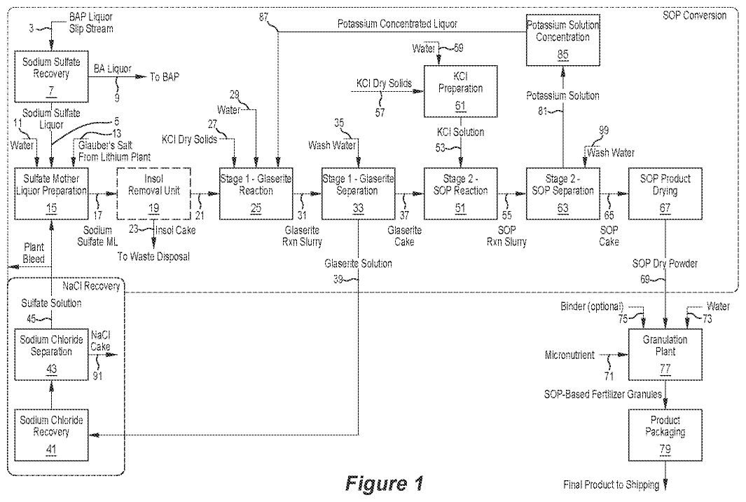

FIG. 1 is a process flowsheet of one, but not the only, embodiment of a process and a plant of the present disclosure.

The flowsheet shown in FIG. 1 produces a fertiliser product for use as a micronutrient enriched fertiliser, general fertiliser, or crops nutrient in soil applications.

The fertiliser product comprises potassium sulfate (sulfate of potash or “SOP”) and boron, wherein the amount of boron is equivalent to 0.2 to 3.0 wt. % B.

Typically, the formulated fertiliser product comprises potassium sulfate (sulfate of potash or SOP) and boron, with the amount of B equivalent to 0.2 to 3.0 wt. % B being selected based on the B demand of targeted crops.

The formulated fertiliser product may also contain other materials, including other micronutrients and a binder.

It is an important consideration in the agricultural fertiliser industry that fertiliser products contain minimum amounts of materials that provide no fertilising benefit (e.g. starch binders). Therefore, typically, the formulated fertiliser product contains minimal amounts of such other materials.

In broad terms, the process shown in FIG. 1 comprises:
(a) blending together potassium sulfate (sulfate of potash or “SOP”) and one or more than one boron-containing compounds,
(b) compacting the blend into granules or pellets; and
(c) crushing, screening and drying the granules or pellets and forming the fertiliser product.

The product formulation produced in the FIG. 1 process flowsheet is in the form of compacted granules of 1-5 mm granule size, typically 1-4 mm granule size.

With reference to FIG. 1, a feed material for the process is a mother liquor slip stream 3 sourced from a boric acid plant (BAP)—not shown.

The BAP mother liquor slip stream 3 contains sodium sulfate, boric acid and other impurities, and boric acid in concentrations depending on the composition of the borate ore and the temperature at which the boric acid is recovered.

It is noted that the disclosure is not confined to sourcing sodium sulphate from a BAP mother liquor slip stream 3. Nevertheless, the use of this source of sodium sulfate is a useful end-use for the BAP mother liquor slip stream 3, which would otherwise be a waste stream in the BAP.

The disclosure extends to the use of sodium sulfate streams that are sourced from any sodium sulfate wastes.

The disclosure also extends to the use of sodium sulfate streams that are sourced from any suitable sodium sulfate material sources that are not necessarily sodium sulfate wastes.

The feed material 3 is transferred to a sodium sulfate recovery unit 7 and formed into a sodium sulfate concentrate liquor 5 and a boric acid (BA) liquor 9.

The sodium sulfate recovery unit 7 may be any suitable unit. Examples of suitable units include a reverse osmosis (RO), a nanofiltration membrane unit, an evaporator and/or a crystalliser.

The boric acid (BA) liquor 9 is recycled to the BAP.

The sodium sulfate concentrate liquor 5 is transferred to a sulfate mother liquor preparation unit 15.

The sodium sulfate concentrate liquor 5, water 11, Glauber's salt (sodium sulfate decahydrate or Na₂SO₄·10H₂O) 13, and a sodium sulfate solution 45 are mixed together in the unit 15 and produce a sodium sulfate mother liquor (ML) 17. By way of example, the sulfate mother liquor preparation unit 15 is a mixing tank.

The Glauber's salt stream is sourced from a lithium plant (not shown). The disclosure is not confined to this source of Glauber's salt.

The sodium sulfate solution 45 is sourced from a downstream step in the process. The disclosure is not confined to this source of sodium sulfate.

The sodium sulfate ML 17 is transferred to a polishing filtration unit 19 or any other suitable unit that removes solid impurities and produces a product stream 21 comprising sodium sulfate in solution and a solid filter cake 23.

The filter cake 23 is a waste product.

The sodium sulfate product stream 21 is converted into potassium sulfate in a two-stage Glaserite reaction with the following reactions (1) and (2) in each respective stage 1 and 2:

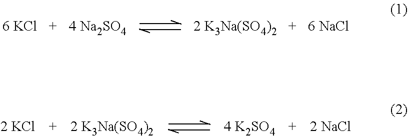

In stage 1, the sodium sulfate stream 21 reacts with potash (KCl) 27, water 29, and a concentrated potassium liquor 87 at near ambient temperature in reactor 25 in accordance with reaction (1) and produces a reaction slurry (S1) 31 comprising Glaserite solids (K₃Na(SO₄)₂) and a soluble sodium chloride solution.

The reaction slurry 31 from stage 1 is transferred to a solid-liquid separation unit 33 that recovers the Glaserite solids as a Glaserite cake 37 and produces a Glaserite solution 39.

The solid-liquid separation unit 33 may be by way of example a centrifugation step that uses wash water 35 to separate a Glaserite cake 37 from the slurry 31.

The Glaserite solution 39 contains soluble sodium chloride. The Glaserite solution 39 is treated in a NaCl recovery unit 41 and sodium chloride separation unit 43 that produces a solid sodium chloride cake 91 and the above-described sodium sulfate solution 45. The sodium sulfate solution 45 is transferred to the sulfate mother liquor preparation unit 15 or disposed of in ponds or other disposal options.

The Glaserite cake 37 produced in the solid-liquid separation unit 33 is transferred to a SOP reactor 51.

The NaCl recovery unit 41 may include but is not limited to, an evaporative crystallization step to precipitate a NaCl solute in combination with or without a prior sulfate separation step by membrane, producing a sodium sulfate concentrate which can be used in the sulfate mother liquor preparation unit or elsewhere in the process. Other suitable technologies to replace the crystallization step may include reverse osmosis and/or nanofiltration step.

The Glaserite cake 37 and a KCl solution 53 are mixed together and allowed to react in the SOP reactor 51 at near ambient temperature in accordance with reaction (2) and produce a reaction slurry (S2) 55 containing potassium sulfate (SOP) solids and a solution containing mainly potassium chloride (from excess KCl added in stage 2), sulfates, and traces of NaCl from the reaction.

The KCl solution 53 is prepared by mixing potash 57 in the form of dry solids and water 59 in a mixing tank 61.

The SOP solids are separated from the reaction slurry 55 in a solid-liquid separation unit 63.

By way of example, the solid-liquid separation unit 63 is a centrifugation step. A wash water 99 is provided and this separates the solids from the reaction slurry 55 and produces an output SOP cake 65 and a centrate 81. The centrate 81 contains a high concentration of potassium and a significant but much lower amount of NaCl.

Other types of solid-liquid separation units may be used.

The centrate 81 is transferred to a potassium solution concentration unit 85 and is concentrated for example by evaporation and produces the above-mentioned concentrated potassium liquor 87 that is supplied to the reactor 25 to contribute to the Glaserite reaction to maximize the yield of potassium. Steam 91 produced in the concentration unit 85 can be used in various units of the SOP production process or elsewhere.

The SOP cake 65 produced in the solid-liquid separation unit 63 is dried in a dryer 67, such as a rotary dryer, forming a dry SOP powdered product 69 and steam 97.

The dry SOP powdered product 69 is combined with a boron-containing compound 71, water 73, and optionally a binder 75 in a granulation plant 77 and forms granules of the SOP+B final product 79.

The steam 97 produced in the dryer 67 can be used in various units of the SOP production process or elsewhere.

Whilst the embodiment shown in FIG. 1 includes the Glaserite reaction in the SOP conversion, it can readily be appreciated that the disclosure is not confined to SOP being produced by the Glaserite process.

For example, SOP may be produced by a Manheim process or any other suitable process.

It is advantageous to use the Glaserite process to produce SOP because sodium sulfate streams are often produced in mineral processing operations such as the boric acid/lithium production operation and are waste streams that have to be stored in ponds, tailings dams, or otherwise disposed of by mine operators.

Currently, there are limited markets for sodium sulfate and significant amounts of sodium sulfate are produced in mineral processing operations.

Some sources of sodium sulfate include a boric acid production operation, a lithium production operation and a boric acid/lithium production operation.

Sodium sulfate can be produced in different ways such as from BAP streams or solid/crystal sodium sulfate in a lithium production operation. There is also sodium sulfate in existing ponds, tailings dams or other storage facilities in boric acid/lithium production processes.

The sodium sulfate waste streams are readily available on site—either as waste streams produced as part of continuing process operations or as stored waste in ponds and tailings dams.

It follows from the above that the use of sodium sulfate waste streams in the present disclosure is potentially beneficial to mine operators.

In addition, the use of sodium sulfate waste streams is an opportunity to reduce production costs of SOP as compared to other options, such as using a Manheim process (i.e. H₂SO₄+KCl) to produce sodium sulfate, or buying sodium sulfate from other sources.

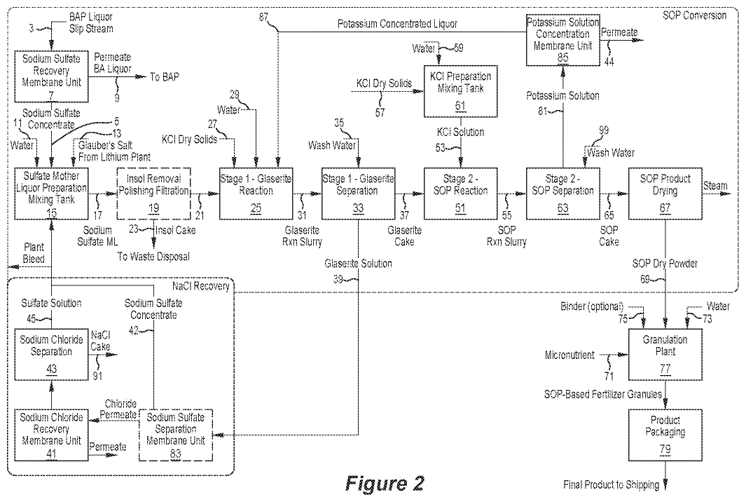

FIG. 2 is a flowsheet illustrating another embodiment of a process and a plant for producing a SOP+B fertiliser product.

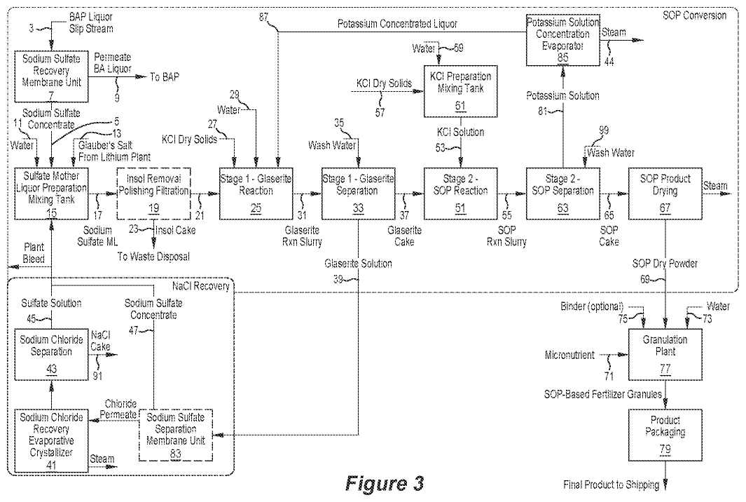

FIG. 3 is a flowsheet illustrating another, but not the only other, embodiment of a process and a plant for producing a SOP+B fertiliser product.

The same reference numerals are used in FIGS. 1-3 to describe the same features.

The flowsheets in FIGS. 1-3 are substantially the same and the following description highlights the differences between the flowsheets.

In the FIG. 2 flowsheet, the sodium sulfate recovery unit 7 is shown as a membrane unit.

In addition, the Glaserite solution 39 produced in the solid-liquid separation unit 33 is treated in a sodium sulfate separation unit 85 in the form of a membrane unit and produces a sodium sulfate concentrate 47 and a chloride containing permeate 49.

The sodium sulfate concentrate 47 is transferred to and becomes part of the sodium sulfate solution 45 that is transferred to the sulfate mother liquor preparation unit 15.

The permeate 49 is transferred to the NaCl recovery unit 41, in this embodiment in the form of a membrane unit, and the sodium chloride separation unit 43 and processed as described in relation to FIG. 1.

The FIG. 3 flowsheet is the same as the FIG. 2 flowsheet, save that the NaCl recovery unit 41 is in the form of an evaporative crystalliser rather than the membrane unit of the FIG. 2 flowsheet.

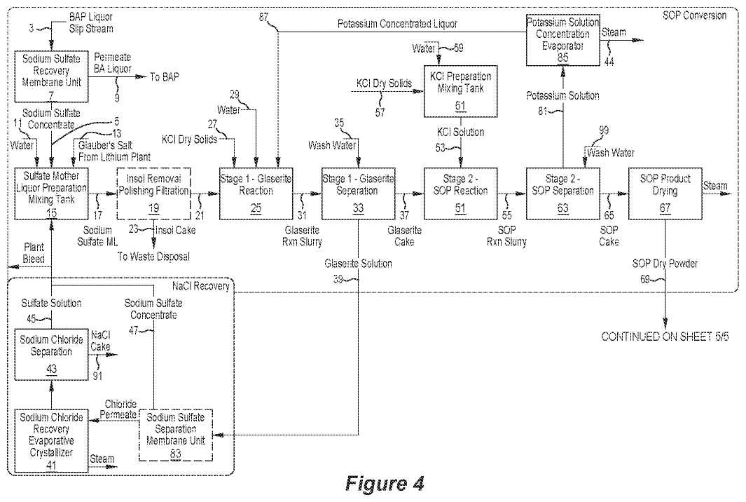

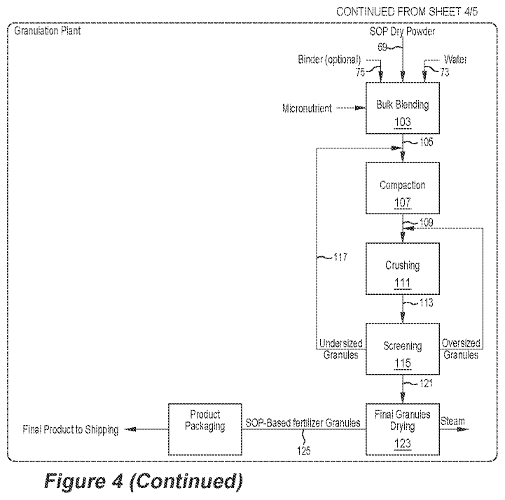

FIG. 4 is a process flowsheet illustrating steps in an embodiment, although not the only embodiment, of a granulation plant 77 according to the present disclosure.

The process steps to form the dry SOP powdered product 69 that is transferred to the granulation plant 77 are the same process steps described in relation to the flowsheets of FIGS. 1-3 and are not repeated here, noting that the same reference numerals are used in FIGS. 1-4 to describe the same features.

A key feature of the embodiment of the process for producing the fertiliser product shown in FIG. 4 is the formulation and compaction of the SOP+B product.

With further reference to FIG. 4, the granulation plant 77 includes a bulk blending unit 103 which mixes together the dry SOP powdered product 69, boron-containing compound 71, water 75, optionally a binder 75, and optionally other micronutrients selected from the above list, in targeted proportions depending on the B nutrient crop demands and produces a blended product 105.

The blended product 105 is compacted and dried in a compaction unit 107, thereby forming granules or pellets 109. The target size of the granules or pellets 109 in the final fertiliser product is 1-5 mm, typically 2-4 mm.

The granules or pellets 109 are crushed in a crusher unit 111 and produce crushed granules or pellets 113.

The crushed granules or pellets 113 are transferred to a screen unit 115 and separated in an oversize fraction 119, and undersize fraction 117, and a product fraction 121.

The undersize fraction 117 are returned to the compaction unit 107 and re-processed.

The oversize fraction 119 are returned to the crusher unit 111 and re-crushed.

The product fraction 121, which a target size granules or pellets, are transferred to a dryer unit 123 and dried to form the final fertiliser product 125.

Many modifications may be made to the embodiments described above without departing from the spirit and scope of the invention.

By way of example, whilst the embodiment shown in the FIG. 4 includes a boron micronutrient, the disclosure is not so limited and extends to other additional micronutrients. For example, the micronutrient may be selected from a group consisting of iron, molybdenum, cobalt, manganese, copper, nickel, zinc or a combination thereof.

By way of further example, whilst the embodiment shown in FIG. 4 is a compaction or dry granulation process, the disclosure is not so limited and extends to other granulation processes. For example, the process may include wet granulation in a disc or other suitable pelletizer or fluidized bed or high energy mixing granulator.

In the embodiment of FIG. 4, the granules or pellets may be slow-release granules. By way of further example, the embodiment of the process shown in FIG. 4 may include coating the granules or pellets with a quick-release coating.

The applicant has carried out development work into the invention described above to better establish how to perform the invention at scale in an efficient manner.

The applicant has conducted bench scale (1 L) trials and prototype batch pilot scale trials (30 L batch) to produce the SOP from sodium waste (Glauber's salt) produced on site at a lithium production plant. The trials demonstrate that it is feasible to produce a product with greater than 95% K₂SO₄ using the two-stage Glaserite process at near ambient temperatures and minimum KCl addition ratios of 0.79 g KCl/g Na₂SO₄ in stage 1 and 0.70 g KCl/g Glaserite in stage 2. The best reaction times and reagent concentrations in the reaction slurry were also determined by testing different parameters in bench scale trials.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A fertiliser product comprising potassium sulfate (sulfate of potash or “SOP”) and boron, wherein the amount of boron is equivalent to 0.2 to 3.0 wt. % B.

2. The fertiliser product defined in claim 1 wherein the amount of boron in the fertiliser product is equivalent to more than 0.5 wt. % B.

3. The fertiliser product defined in claim 1 wherein the amount of boron in the fertiliser product is equivalent to be no more than 1.5 wt. % B.

4. The fertiliser product defined in claim 1 wherein the boron is in any one or more than one of the boron-containing compounds boric acid, borax pentahydrate, anhydrous borax, boric oxide, kernite, ulexite, colemanite, hydroboracite, borax decahydrate, zinc borate, tincal and disodium octaborate tetrahydrate (DOT) or combinations thereof.

5. The fertiliser product defined in claim 1 being in a form of compacted granules or pellets.

6. The fertiliser product defined in claim 1 being in a form of granules or pellets and a coating to control the release of macronutrients and micronutrients from the granules or pellets.

7. A process for producing a fertiliser product comprising:
blending together potassium sulfate (sulfate of potash or “SOP”) and one or more than one boron-containing compound and optionally one or more than one other micronutrients; and
compacting, agglomerating or otherwise forming the blended potassium sulfate and boron-containing compound(s) into granules or pellets.

8. The process defined in claim 7 comprises forming SOP by a Glaserite process.

9. The process defined in claim 8 comprises supplying a sodium sulfate waste stream and potassium chloride as feed materials for the Glaserite process.

10. The process defined in claim 7 comprises crushing the compacted granules or pellets.

11. The process defined in claim 10 comprises classifying the crushed granules or pellets and separating the crushed granules or pellets on the basis of size and forming a product fraction.

12. The process defined in claim 10 comprises classifying the crushed granules or pellets into an oversize fraction, a product fraction, and an undersize fraction.

13. The process defined in claim 12 comprises returning the oversize fraction to the crushing step.

14. The process defined in claim 13 comprises returning the undersize fraction to the compaction step.

15. A process for producing a fertiliser product that comprises potassium sulfate (sulfate of potash or “SOP”) and boron, the process comprising:
blending together SOP and one or more than one boron-containing compounds,
compacting, agglomerating or otherwise forming the blend into granules or pellets,
screening or otherwise classifying the granules or pellets and forming a product fraction, and drying the granules or pellets in the product fraction and forming the fertiliser product.

16. The process defined in claim 15 comprises making SOP to be supplied to the blending step by processing a sodium sulfate waste stream and potassium chloride, for example in a Glaserite process, and forming SOP.

17-18. (canceled)
